(19) United States
(12) Patent Application Publication
(10) Pub. No.: US 2006/0183374 A1
(43) Pub. Date: Aug. 17, 2006

(54) Sealing end for a heat conductor and method of constructing same

(75) Inventors: Ming-Cyuan Shih, Jhubei City (TW); Sin-Wei He, Jhudong Township (TW); Jhong-Yan Chang, Chu Pei City (TW)

Correspondence Address: John S. Egbert;Harrison & Egbert, 7th Floor, 412 Main Street, Houston, TX, 77002, US

(73) Assignee: FORCECON TECHNOLOGY Co., Ltd., Chu Pei City (TW)

(21) Appl. No.: 11/056,426

(22) Filed: Feb. 14, 2005

(51) Int. Cl. H01R 13/40

(52) U.S. Cl. 439/587

(57) ABSTRACT

The sealing method and construction of the sealing end for a heat conductor includes a heat conductor for vacuum pumping and sealing placed within an enclosed operating space, wherein an open end is preset for the heat conductor. Next, vacuum pumping is performed for entire enclosed operating space, thereby finishing the vacuum pumping procedure of heat pipe. Then, the open end of heat pipe is welded by fusing within enclosed operating space, wherein the sealing end of heat conductor forms a welded close end. A compression procedure can be neglected, thereby saving more manufacturing cost and offering a higher structural strength for the sealing part.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX.

Not applicable.

### FIELD OF THE INVENTION

The present invention relates generally to a heat conductor, and more particularly to a heat conductor that is exclusively intended for overall or partial vacuum pumping in an enclosed environment via a sealing method or sealing by fusing without compression joint.

### BACKGROUND OF THE INVENTION

To ensure a better heat conduction effect, a heat conductor is generally fitted with an opening at one side for vacuum pumping. After that, it is required to keep the vacuum constant by sealing this preset opening. The present invention is intended to improve the sealing method and construction of sealing end of heat conductor. As shown in FIGS. 7-8 for the sealing method of typical heat conductor's sealing end, the heat conductor (i.e. a heat pipe 40) is firstly pumped out, and then the open end is sealed by compression method. Next, a sealing end 42 is shaped at end of compression part 41 via a welding method. However, the sealing method and construction for typical heat pipe will yield the following problems in practical applications:
1. Owing to excessive amount of deformation at the compressed part of heat pipe, fatigue of materials will likely lead to vulnerable crack against a vacuum state at the moment of compression or in the future.
2. The overall sealing behavior of heat pipe must cover a time-consuming compression and welding process, which cannot meet the demanding requirement of higher availability.
Thus, to overcome the aforementioned problems of the prior art heat conductor, it would be an advancement in the art to provide an improved one that offers higher availability by an ideal sealing method and construction.

To this end, the inventors have provided the present invention ofpracticability after deliberate design and evaluation based on years of experience in the production, development and design of related products.

### BRIEF SUMMARY OF THE INVENTION

1. Based on the innovative design of the present invention that vacuum pumping and welding by fusing is performed within an enclosed operating space of heat conductor, the compression procedure can be neglected during sealing of a heat conductor, thereby saving manufacturing cost for the benefit of this industry in an easy and efficient way.

2. Since the sealing end of heat conductor for vacuum pumping is only designed with a welded close end, no deformation from compression of typical heat conductor's sealing end will occur, thus offering a higher structural strength, longer service life and higher availability.

### BRIEF DESCRIPTION OF THE SEVERAL VIEWS OF THE DRAWINGS

FIG. 1 shows the first diagram of the sealing method of sealing end for a heat conductor.

FIG. 2 shows the second diagram of the sealing method of sealing end for a heat conductor.

FIGS. 3-4 show the diagram of the preferred embodiment of the seal end of the heat conductor.

FIGS. 5-6 show the diagram of the preferred embodiment of the heat conductor.

FIG. 7 shows a perspective exterior view of the seal end of the heat conductor.

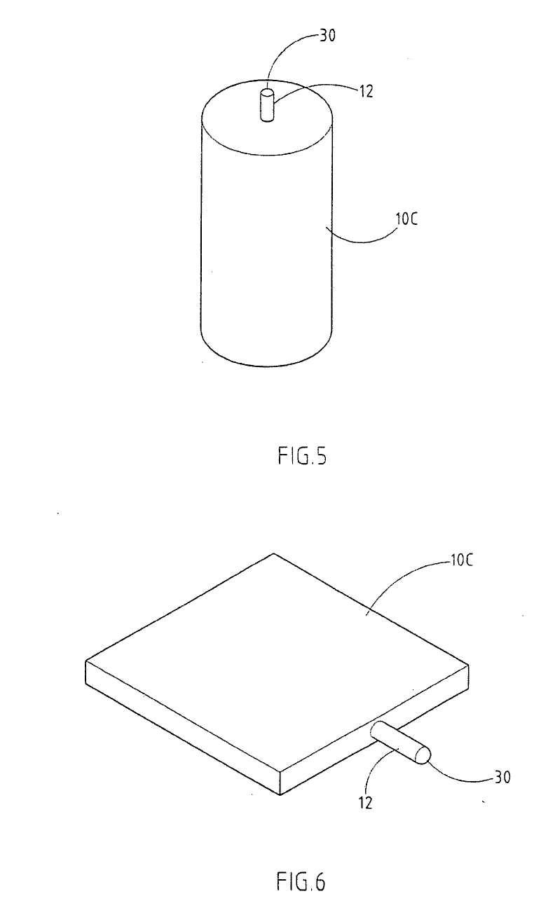

FIG. 8 shows a plane cutaway view of the seal end of the heat conductor.

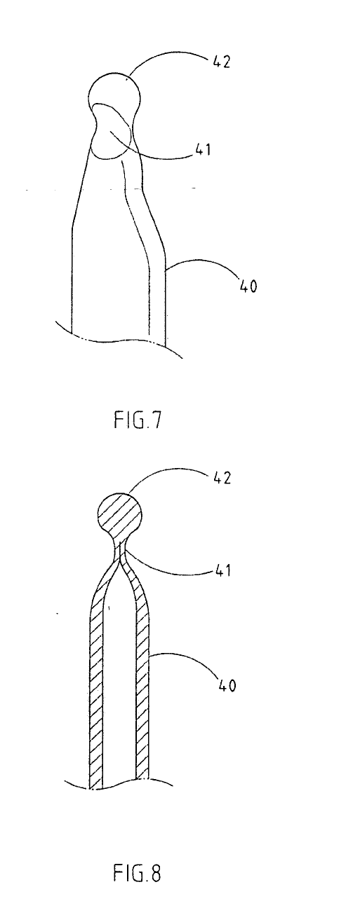

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

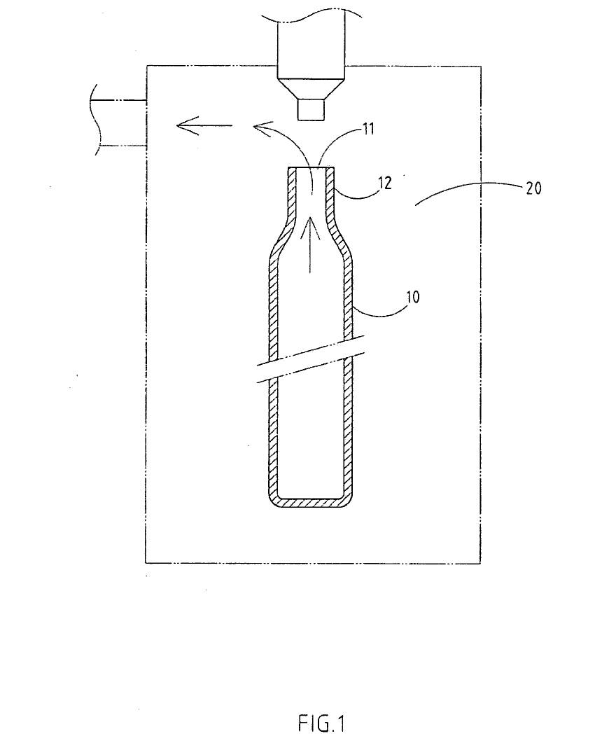

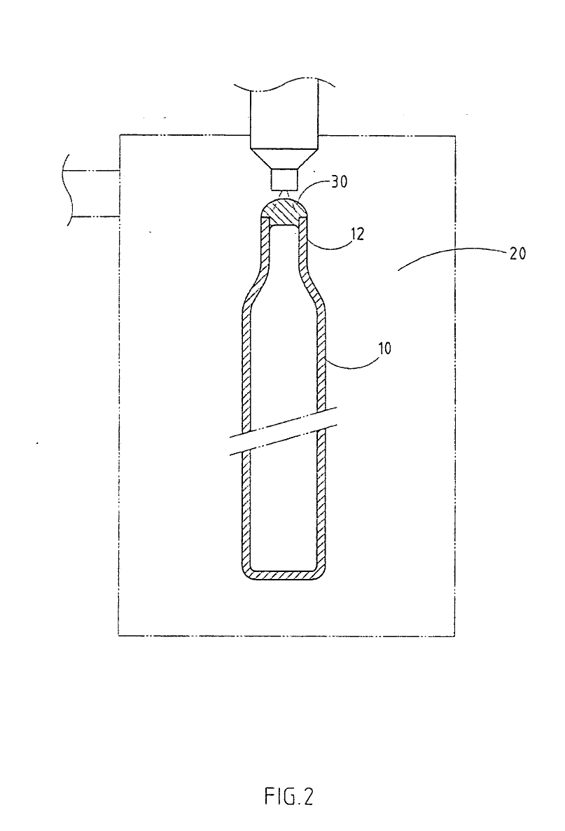

As shown in FIGS. 1-4, the sealing method and construction of sealing end for a heat conductor embodied in the present invention, in which the heat conductor is a heat pipe 10; the features of its sealing method are:
a. A preset enclosed operating space 20, wherein a heat pipe 10 for vacuum pumping and sealing is wholly or partially placed and an open end 11 is preset for the heat pipe 10;
b. As shown in FIG. 1, vacuum pumping is performed for entire enclosed operating space 20, thereby finishing the vacuum pumping procedure of the heat pipe 10; and
c. As shown in FIG. 2, the open end 11 of a heat pipe 10 is welded by fusing within enclosed operating space 20, wherein a welded close end 30 is formed.

Of which, a single or several heat pipes 10 can be mounted within the said enclosed operating space 20, where vacuum pumping and welding by fusing is performed simultaneously.

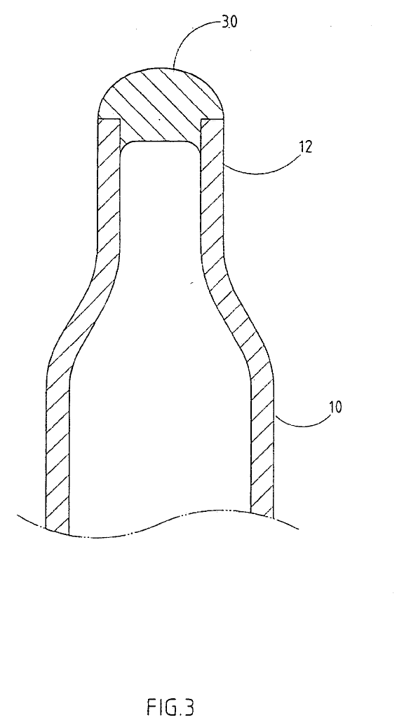

Based on above-specified structure of heat pipe as shown in FIGS. 2-3, a hollow space is provided within a heat pipe 10, and two close ends at both sides, one of which is a sealing end 12 for vacuum pumping. The feature is: the sealing end 12 is a welded close end 30.

As shown in FIG. 3, the sealing end 12 of a heat pipe 10 can be designed with a shrinkage pipe.

As shown in FIG. 4, the sealing end 12B of a heat pipe lOB can also be designed with a straight pipe.

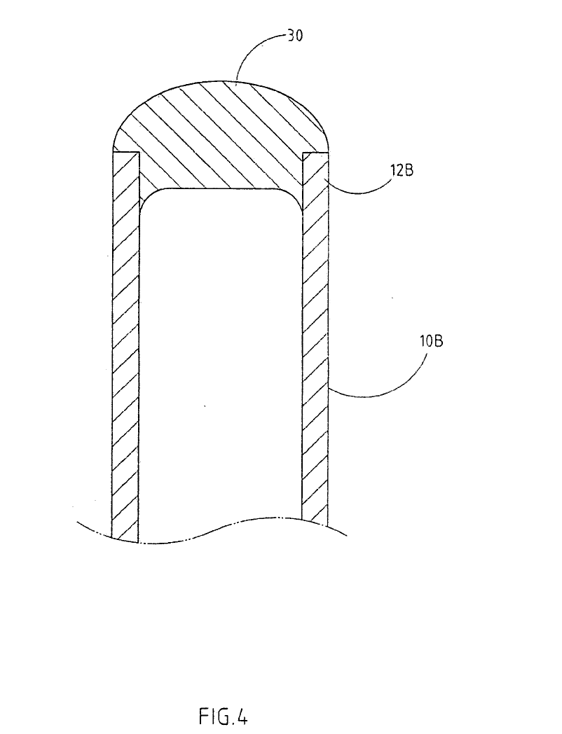

In addition to aforesaid heat pipes designed for the heat conductor of present invention, the heat conductor 10C can also be designed with a turreted space, with its sealing end 12 installed at one side of the turreted body as shown in FIG. 5. And, a heat conductor 10D can be designed with a plate profile, with its sealing end 12 installed at one side of this plate as shown in FIG. 6.

1. A method of sealing an end for a heat conductor, said method comprising:
placing, in a preset enclosed operating space, a heat pipe for vacuum pumping and sealing wholly or partially therein, an open end being preset for the heat pipe;
vacuum pumping performed for the enclosed operating space, thereby finishing vacuum pumping procedure of heat pipe; and
welding an open end of the heat pipe by fusing within enclosed operating space, wherein a heat conductor with a welded close end is formed.

2. The sealing method of sealing end for a heat conductor as defined in claim 1, further comprising: mounting a single or several heat pipes within the enclosed operating space, where vacuum pumping and spot welding is performed simultaneously.

3. A sealing end for a heat conductor, said sealing end comprising:
a hollow space within a heat pipe, with one sealing end for vacuum pumping, said sealing end being a welded close end.

4. A sealing end for a heat conductor as defined in claim 3, wherein sealing end of said heat pipe is comprised of a shrinkage pipe or a straight pipe.

5. A sealing end for a heat conductor as defined in claim 3, wherein said heat conductor is comprised of piping, turreted or plate profiles.
